(19) United States
(12) Patent Application Publication
(10) Pub. No.: US 2004/0059816 A1
(43) Pub. Date: Mar. 25, 2004

(54) Computer management system and management program

(75) Inventors: Nobumitsu Takaoka, Tokyo (JP); Ken?apos;ichi Soejima, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/618,433

(22) Filed: Jul. 10, 2003

(30) Foreign Application Priority Data
Sep. 24, 2002 (JP) 2002-276554

(51) Int. Cl. G06F 15/173; G09G 5/00

(52) U.S. Cl. 709/224; 345/736

(57) ABSTRACT

Management software, a management computer, and a management method capable of visualizing connection relationships among a plurality of devices interconnected over a storage network without the necessity of implementing connection information acquiring means in an object computer have been unavailable in the past. A computer system in accordance with an embodiment of the present invention comprises an object computer, a storage system in which data to be communicated to the object computer is stored, and a management computer that manages the storage system and the object computer. The storage system includes: an acquisition unit that acquires first connection information, which contains a communication port identifier assigned of the object computer, and a communication port identifier assigned to the communication port of the storage system, from the object computer; and a communication unit that transmits the first connection information to the management computer. The management computer includes a communication unit that receives the first connection information from the storage system, and a display that uses an output screen thereof to visualize the connection relationships between the storage system and object computer on the basis of the first connection information.

### BACKGROUND OF THE INVENTION

1. Field of the Invention

The present invention relates to a method of visualizing the connection relationships between a storage system and an object computer that is an object of management which is implemented in a management computer.

2. Description of the Related Art

In recent years, a storage network having a storage system and a computer interconnected has accommodated a management computer responsible for management. Management software dedicated to the storage network is installed in the management computer in order to grasp the complex connection relationships among devices (refer to, for example, Patent Document 1: Abstract of U.S. Pat. No. 6,253,240). The management computer runs the management software, whereby the connection relationships among a plurality of data processing devices interconnected over the storage network can be visualized.

A procedure of visualizing the connection relationships among a plurality of devices interconnected over the storage network, which is implemented in conventional management software, will be described below.

First, the management software acquires equipment identifiers inherent to an object computer and a storage system, which are connected to an interconnection device connected to a management computer, from the interconnection device. Thereafter, the management software acquires the equipment identifiers and an equipment identifier assigned to a data processing device connected to the management computer, from the data processing device. The management software then visualizes the connection relationships within the network according to the acquired information.

The conventional management software uses a unit for acquiring equipment identifiers from a data processing device to acquire equipment identifiers from the connected data processing device. The object computer runs an agent program that acts as the unit for acquiring an equipment identifier, and thus acquires the equipment identifier of the connected data processing device.

The management software cannot therefore acquire an identifier of a data processing device, which is included in an object computer, from the object computer unless the agent program is installed (or can be installed) in the object computer. In particular, the management software cannot acquire an identifier of a data processing device included in an object computer in which the agent program is not installed and which is directly connected to the management computer without intervention of an interconnection device. Consequently, the conventional management software cannot acquire an identifier of a certain data processing device and may not be able to visualize the connection relationships within a network.

Moreover, the agent program deteriorates the ability of a computer to run certain transaction software that is one of the principal objects of a computer because the agent program consumes computer resources including a memory and a CPU incorporated in a computer. Furthermore, the cost required for introduction and maintenance of the agent program increases in proportion to the number of computers. Furthermore, the agent program is inherent to management software and dependent on features included in a computer platform. Management software developers must develop an agent program for each platform. This leads to the high cost of development.

### SUMMARY OF THE INVENTION

Accordingly, an object of the present invention is to solve the foregoing problems and to provide management software, a management computer, and a management method capable of visualizing the connection relationships among a plurality of devices interconnected over a storage network without the necessity of implementing a connection information acquiring unit in an object computer.

Management software uses an identify inherent to a data processing device to grasp a connection relationship. For example, according to a fibre channel (FC) application for storage area network (SAN), a worldwide name (WWN) is adopted as an identifier. The WWN is represented by an integer of 64 bits associated with an FC communication port or a data processing device. Moreover, the Internet small computer systems interface (iSCSI) protocol stipulates the employment of an iSCSI name as an identifier. Furthermore, in a storage network adopting the transmission control protocol/Internet protocol (TCP/IP) such as the iSCSI, iFCP, or NAS, an IP address assigned to a communication port may be used as an identifier.

Moreover, the communications protocols including the FCP and iSCSI define a procedure of establishing a data communications link between data processing devices so as to permit intended data communication. What is referred to as intended data communication signifies access to a storage system gained by a computer (for storage of data in the storage system or fetch thereof from the storage system). The FCP defines a procedure called a port login as the above sort of procedure. The iSCSI defines a procedure called an iSCSI login. Some protocols do not require the procedure. In this specification, a state in which a procedure of terminating intended data communication is completed, or a state in which an established link for communication cannot be sustained because of a physical disconnection between devices caused by a fault occurring in a device among devices connected to the storage network shall be expressed as a state in which “a data communications link is lost.” According to a procedure of establishing a data communications link, identifiers assigned to communication ports of connected data processing devices are transmitted to the partner devices of communication.

A computer system in accordance with an embodiment of the present invention comprises an object computer, a storage system in which data to be communicated to the object computer is stored, and a management computer that manages the storage system and object computer. The storage system includes: an acquisition unit that acquires first connection information, which contains an identifier assigned to the communication port of the computer and an identifier assigned to the communication port of the storage system, from the object computer; and a communication unit that transmits the first connection information to the management computer. The management computer includes a communication unit that receives the first connection information from the storage system, and a display that uses the output screen thereof to visualize the connection relationships between the storage system and computer according to the first connection information.

### BRIEF DESCRIPTION OF THE DRAWINGS

FIG. 1 shows a computer system in accordance with an embodiment of the present invention;

FIG. 2 shows the internal configuration of a storage system;

FIG. 3 shows the internal configuration of the storage system;

FIG. 4 shows communication port information concerning the storage system;

FIG. 5 shows connection information concerning the storage system;

FIG. 6 shows communication port information concerning the storage system;

FIG. 7 shows connection information concerning the storage system;

FIG. 8 shows the internal configuration of a management computer;

FIG. 9 shows a connection relationship diagram produced by the first embodiment;

FIG. 10 shows integrated connection information preserved in the management computer included in the first embodiment;

FIG. 11 describes an overall processing flow according to which management software included in the first embodiment displays a connection relationship diagram;

FIG. 12 describes a processing flow according to which the management software acquires connection information from the storage system so as to produce integrated connection information;

FIG. 13 describes a processing flow according to which the management software displays a connection relationship diagram on the basis of the integrated connection information;

FIG. 14 shows information concerning the computer contained in the integrated connection information;

FIG. 15 shows a connection relationship diagram that contains a graphic expressing the computer and that is produced by the first embodiment;

FIG. 16 shows a connection relationship diagram produced by a second embodiment;

FIG. 17 shows the internal configuration of an interconnection device;

FIG. 18 shows the internal configuration of a management computer included in the second embodiment;

FIG. 19 shows connection information preserved in the interconnection device;

FIG. 20 shows information concerning the interconnection device which is contained in integrated connection information;

FIG. 21 describes a processing flow according to which management software included in the second embodiment displays a connection relationship diagram;

FIG. 22 describes a processing flow according to which the management software acquires information from the interconnection device so as to produce integrated connection information; and

FIG. 23 describes a processing flow according to which the management software included in the second embodiment displays a connection relationship diagram on the basis of the integrated connection information.

### DESCRIPTION OF THE PREFERRED EMBODIMENTS

A first embodiment of the present invention will be described below. According to the first embodiment, management software visualizes the connection relationships between a storage system and a computer on the basis of connection information acquired from the storage system.

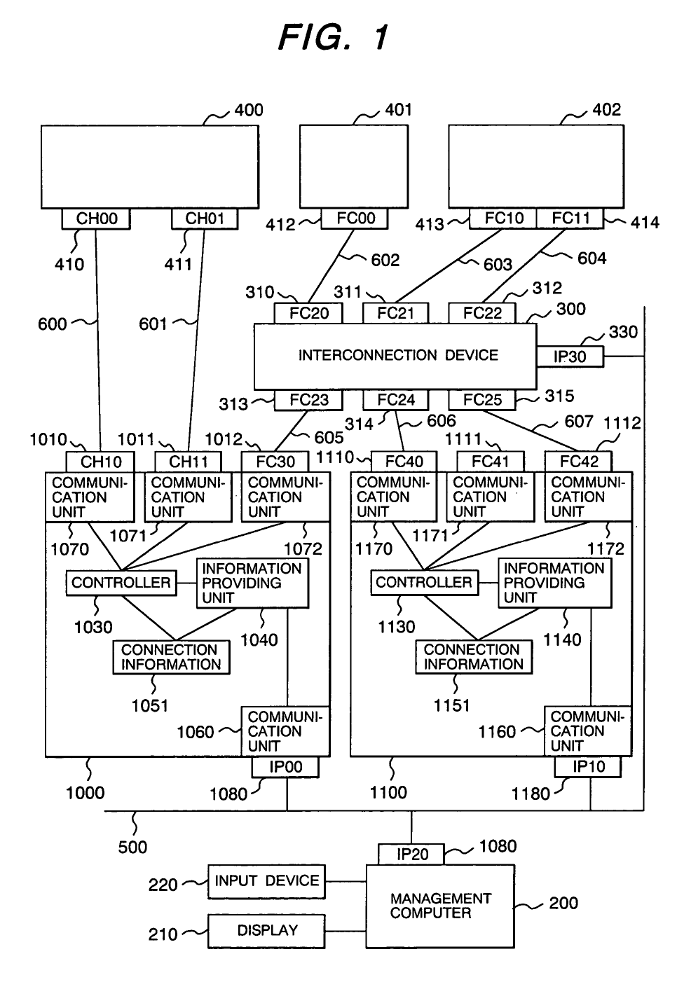

FIG. 1 shows a computer system in accordance with the first embodiment.

The computer system shown in FIG. 1 comprises: a storage system 1000 having communication ports 1010 to 1012 and a management communication port 1080; a storage system 1100 having communication ports 1110 to 1112 and a management communication port 1180; a management computer 200 having a communication port 260 and having a display 210 and an input device 220 connected thereto; an interconnection device 300 having communication ports 310 to 315 and a management communication port 330; a computer 400 having communication ports 410 and 411; a computer 401 having a communication port 412; a computer 402 having communication ports 413 and 414; a network 500; and communication paths 600 to 607.

The communication port 410 of the computer 400 is connected to the communication port 1010 of the storage system 1000 over the communication path 600. The communication port 411 of the computer 400 is connected to the communication port 1011 of the storage system 1000 over the communication path 601.

The communication port 310 of the interconnection device 300 is connected to the communication port 412 of the computer 401 over the communication path 602. The communication port 311 is connected to the communication port 413 of the computer 402 over the communication path 603. The communication port 312 is connected to the communication port 414 of the computer 402 over the communication path 604. The communication port 313 is connected to the communication port 1012 of the storage system 1000 over the communication path 605. The communication port 314 is connected to the communication port 1110 of the storage system 1100 over the communication path 606. The communication port 315 is connected to the communication port 1112 of the storage system 1100 over the communication path 607.

The computer 400 accesses the storage system 1000 using the communication paths 600 and 601.

The computer 401 accesses the storage system 1100 only. For the access, the computer 401 uses the communication paths 602 and 605.

The computer 402 accesses the storage systems 1000 and 1100. The computer 402 uses the communication paths 603 and 605 to access the storage system 1000, and uses the communication paths 603, 604, and 607 to access the storage system 1100.

The communication ports 310 to 315 of the interconnection device 300 are discriminated from one another with respective communication port identifiers FC20, FC21, FC22, FC23, FC23, and FC25.

The communication ports 410 and 411 of the computer 400 are discriminated from each other with respective communication port identifiers CH00 and CH01.

The communication port 412 of the computer 401 is identified with a communication port identifier FC00.

The communication ports 413 and 414 of the computer 402 are discriminated from each other with respective communication port identifiers FC10 and FC11.

The communication ports 1010 and 1011 of the storage system 1000 are discriminated from each other with respective communication port identifiers CH10 and CH11, and the communication port 1012 is identified with a communication port identifier FD30.

The communication ports 1110 to 1112 of the storage system 1100 are discriminated from one another with respective communication port identifiers FC40, FC41, and FC42.

The management communication port 1080 of the storage system 1000, the management communication port 1180 of the storage system 1100, the communication port 260 of the management computer 200, and the management communication port 330 of the interconnection device 300 are connected on the network 500. The management communication ports 1080 and 1180, and the communication port 260 are discriminated from one another with respective communication port identifiers IP00, IP10, and IP20. The management communication port 330 of the interconnection system 300 is identified with a communication port identifier IP30.

The foregoing communication port identifiers are different from those assigned to actual communication ports and determined for convenience in describing the present embodiment. In practice, the communication port identifiers are determined appropriately based on a data transfer architecture adopted for communication ports and a communications protocol adopted for data communication. For example, if the fibre channel (FC) is adopted as the data transfer architecture for communication ports, the communication port identifiers are worldwide names (WWN). If the iSCSI is adopted as the communications protocol, the communication port identifiers are iSCSI names or IP addresses.

The storage system 1000 includes a controller 1030, an information providing unit 1040, connection information 1051, a communication unit 1060, and communication units 1070 to 1072. Moreover, the storage system 1100 includes a controller 1130, an information providing unit 1140, connection information 1151, a communication unit 1160, and communication units 1170 to 1172. The internal configuration of the storage systems 1000 and 1100 will be described below.

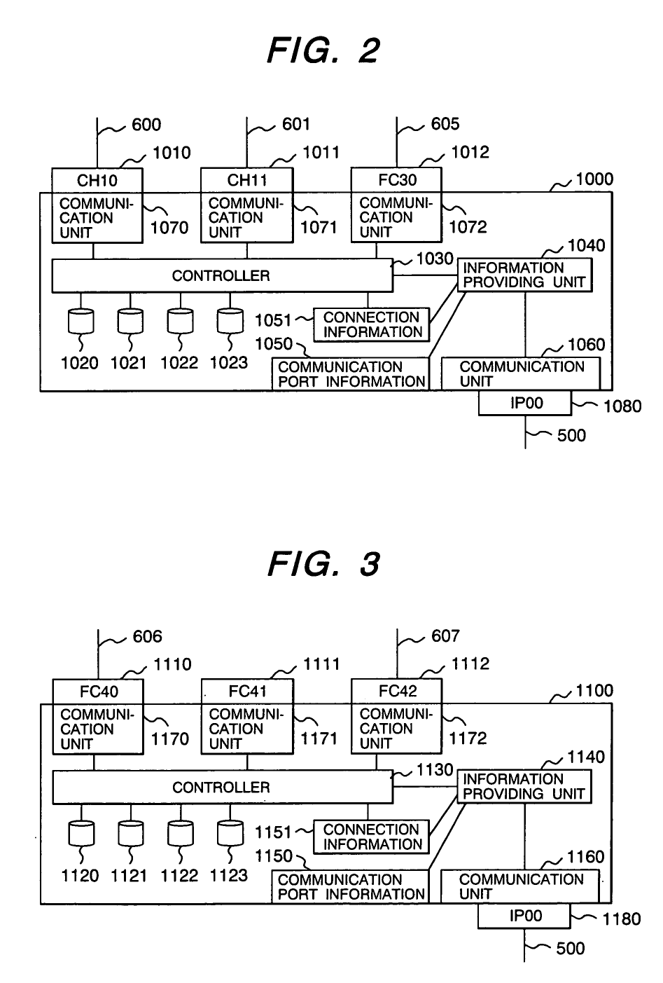

FIG. 2A shows the internal configuration of the storage system 1000. The storage system 1000 includes communication port information 1050 and storage areas 1020 to 1023, in addition to the controller 1030, information providing unit 1040, connection information 1051, communication unit 1060, and communication units 1070 to 1072.

The communication ports 1010 to 1012 are assigned identifiers 0 to 2. In the storage system 1000, the communication ports 1010 to 1012 are discriminated from one another with the identifiers. Hereinafter, the identifiers assigned to the communication ports shall be called internal communication port numbers.

The communication units 1070 to 1072 have communication ports 1010 to 1012 respectively, and are responsible for data communications with external computers. The communication unit 1070, 1071, or 1072 receives an access request sent from an external computer over the communication path 600, 601, or 605, and the controller 1030 deals with the access request.

The controller 1030 appropriately stores data in any of the storage areas 1020 to 1023 in response to a data storage request sent from an external computer. Moreover, the controller 1030 appropriately reads data from any of the storage areas 1020 to 1023 in response to a data reading request sent from an external computer, and transmits the data to any of the communication units 1070 to 1072 from which the controller 1030 has received the request. The controller 1030 fills the role of specifying the connection relationships among the external computers and the communication ports 1010 to 1012 in the connection information 1051. The role of the controller 1030 will be described in conjunction with the data format of the connection information 1051 later.

The information providing unit 1040 also plays the role of an acquisition unit for acquiring the connection information 1051 from the computers 400 and 402 connected to the storage system 1000. Herein, the connection information 1051 represents the connection relationships among equipment, that is, the relationships among the communication ports 1010, 1011, and 1012 of the storage system 1000 and the communication ports 410, 411, and 413 of the computers 400 and 402 that are connected to the communication ports 1010, 1011, and 1012 respectively.

The information providing unit 1040 transmits the communication port information 1050 or connection information 1051 in response to a transmission request for the communication port information 1050 or connection information 1051 from an external computer connected on the network 500. In the series of communication steps, the communication unit 1060 is employed. The communication unit 1060 has the management communication port 1080 and is responsible for data communication with the external computers over the network 500. Herein, the communication port information 1050 contains information concerning the communication ports 1010 to 1012. A program for implementing the information providing unit 1040 is stored in a recording medium such as a ROM. After saved in a main storage device, the program is loaded into the storage unit included in the storage system 1000, and run by the controller 1030. A medium in which the program is recorded may be any recording medium other than the CD-ROM. Moreover, the program may be installed in the storage unit from the recording medium, or the recording medium may be accessed over the network in order to use the program. Moreover, the hardware configuration of the information providing unit 1040 may be determined so that the hardware of the information providing unit 1040 will operate independently of the controller 1030 included in the storage system 1000.

Herein, the storage system 1000 has four communication ports, that is, the communication ports 1010 to 1012 and the management communication port 1080. The number of communication ports will not limit storage systems to which the present invention can be adapted.

Moreover, the communication unit 1060 may be, similarly to the communication units 1070 to 1072, connected to the controller 1030. Moreover, the management communication port 1080 may be, similarly to the communication ports 1010 to 1012, used to receive an access request from an external computer. In this case, the information providing unit 1040 uses the communication unit 1060 via the controller 1030.

Furthermore, the storage system 1000 has four storage areas 1020 to 1023. The number of storage areas will not limit storage systems to which the present invention can be adapted.

FIG. 3 shows the internal configuration of the storage system 1100.

The storage system 1100 includes storage areas 1120 to 1123, a controller 1130, an information providing unit 1140, a communication unit 1160, communication units 1170 to 1172, communication port information 1150, and connection information 1051, in addition to the communication ports 1110 to 1112 and the management communication port 1180.

According to the present embodiment, the storage system 1100 has the same configuration as the storage system 1000 does. The details of the storage system 1100 will therefore be omitted. However, information concerning the communication ports 1110 to 1112 of the storage system 1100 is specified in the communication port information 1150, and information concerning the external computers connected via the communication ports 1110 to 1112 is specified in the connection information 1151. Moreover, the present invention can be adapted to a computer system including at least one storage system that transmits information analogous to the communication port information and connection information to external computers.

Similarly to those of the storage system 1000, the communication ports 1110 to 1112 of the storage system 1100 are assigned internal communication port numbers 0 to 2. The controller 1130 included in the storage system 1100 uses the internal communication port numbers to discriminate the communication ports 1110 to 1112 from one another.

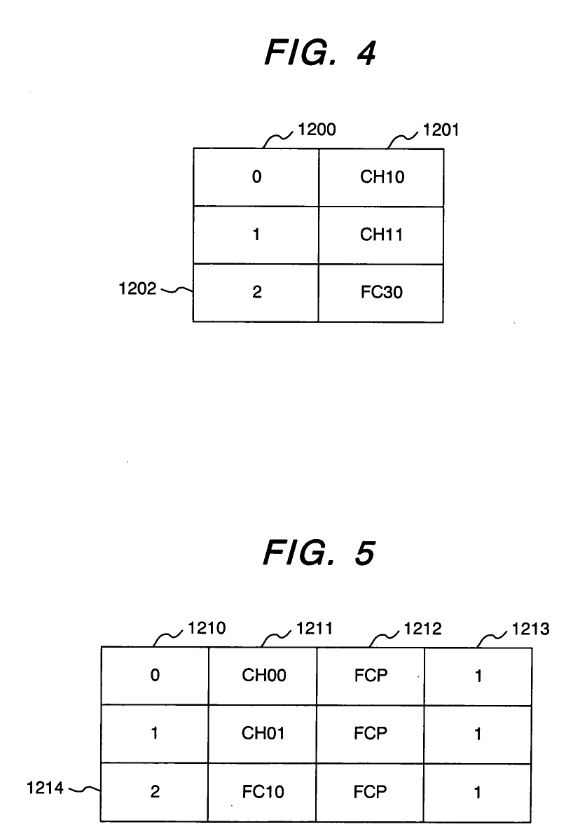

FIG. 4 shows the contents of the communication port information 1050. The format of the communication port information 1050 is a table having three rows and two columns. The rows in the communication port information 1050 are associated with the communication ports 1010 to 1012.

The internal communication port numbers assigned to the communication ports 1010 to 1012 of the storage system 1000 are specified as the items belonging to the rows and the first column 1200 in the communication port information 1050. The communication port identifiers assigned to the communication ports 1010 to 1012 that are discriminated from one another with the internal communication port numbers specified in the first column are specified in the second column 1201. For example, the third row 1202 specifies that the communication port 1012 whose internal communication port number is 2 has a communication port identifier of FC30.

Herein, the communication port information 1050 is formatted as the table having three rows and two columns. The communication port information 1050 may assume any format as long as the foregoing information concerning all communication ports via which the external computers can access the storage system 1000 can be specified. Moreover, the communication port information 1050 may have information other than the aforesaid one specified in a row or column therein.

FIG. 5 shows the contents of the connection information 1051 preserved in the storage system 1000.

The format of the connection information 1051 is a table having three rows and four columns. Each of the rows in the connection information 1051 specifies the connection relationship between each of the communication ports 1010 to 1012 of the storage system 1000 and each of the communication ports 410 to 414 of the computers 400 to 402.

The internal communication port numbers of the communication ports 1010 to 1012 are specified as the items belonging to the respective rows and the first column 1210 in the connection information 1051. The communication port identifiers of the communication ports 410 to 414 of the computers 400 to 402 connected to the communication ports 1010 to 1012 discriminated from one another with the communication port numbers specified in the first column are specified in the second column 1211. Character strings each expressing a communications protocol adopted for data communication between the communication ports identified with the items specified in the first and second columns are specified in the third column. Numerical values each indicating whether a communications link between the communication ports identified with the items specified in the first and second columns is established are specified in the fourth column. A value of 1 signifies that a communications link has been established, a value of 0 signifies that a communications link has been lost.

When the storage system and an external computer agree on a communications protocol that does not stipulate a procedure of starting communication, 1 is specified as an item of the connection information 1051 belonging to the fourth column 1213. The third column 1214 demonstrates that the communication port 1012 of the storage system 1000 and the communication port 413 of the computer 402 agree on a communications protocol of the FCP, and have a communications link established between them.

When a communications link is established between any of the communication ports 1010 to 1012 and an associated one of the communication ports of the external computers, the controller 1030 specifies the fact in the connection information 1051 according to the foregoing format. At this time, if a row of items signifying that a communications link between communication ports has been lost is contained in the connection information 1051, 1 is specified as an item belonging to both the row and the fourth column. If the row of items is not contained, a row of items signifying that a communications link between the communication ports has been established is additionally specified in the connection information 1051. Moreover, if a communications link between any of the communication ports 1010 to 1012 and any of the communication ports of the computers is lost, 0 is specified as an item belonging to both the row indicating that the communications link between the communication ports has been established, and the fourth column.

The present invention is not limited to the format shown in FIG. 5. The present invention can be adapted to storage systems each having the foregoing information items that signify the connection relationships among communication ports.

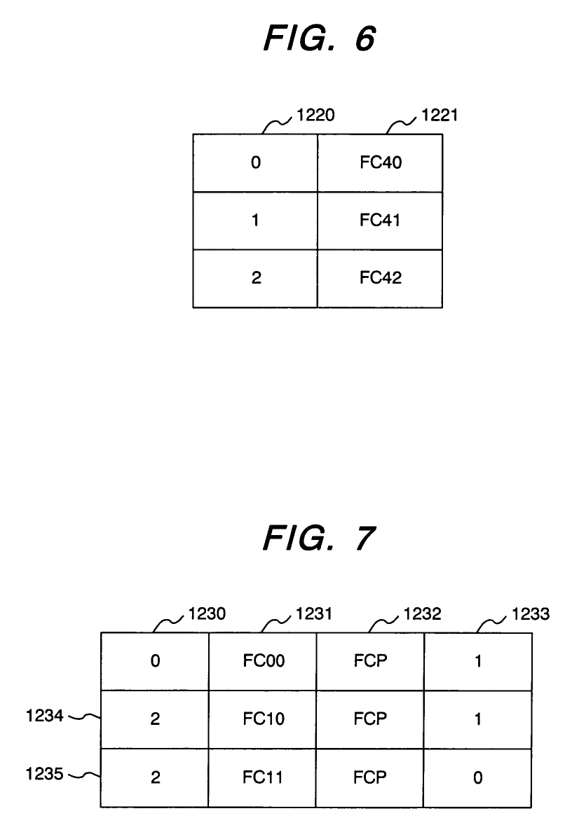

FIG. 6 shows the contents of the communication port information 1150 preserved in the storage system 1100. The format of the communication port information 1150 is identical to that of the communication port information 1050 preserved in the storage system 1000 shown in FIG. 4. However, the communication port information 1150 specifies information concerning the communication ports 1110 to 1112 of the storage system 1100. Namely, the internal communication port numbers assigned to the communication ports 1110 to 1112 are specified in the first column 1220, and the communication port identifiers assigned to the communication ports 1110 to 1112 are specified in the second column 1221.

FIG. 7 shows the contents of the connection information 1151 preserved in the storage system 1100. The format of the connection information 1151 is identical to that of the connection information 1051 preserved in the storage system 1000 shown in FIG. 5. However, the connection information 1151 specifies the connection relationship between each of the communication ports 1110 to 1112 of the storage system 1100 and each of the communication ports 410 to 414 of the computers 400 to 402 which are connected to the communication ports 1110 to 1112.

Referring to the second column 1234 and the third column 1235, 2 is specified in the first column. The two rows signify the respective connection relationships of the communication port 413 of the computer 402 and the communication port 414 thereof to the communication port 1112 identified with the internal communication port number 2. Moreover, 0 is specified as an item belonging to both the third row 1235 and the fourth column. The value of 0 signifies that no communications link is established between the communication port 1112 of the storage system 1100 and the communication port 414 of the computer 402.

When the data communications link between the communication port of an external computer and any of the communication ports 1120 to 1123 of the storage system 1100 has changed, the controller 1130, similarly to the controller 1030, modifies the connection information 1151.

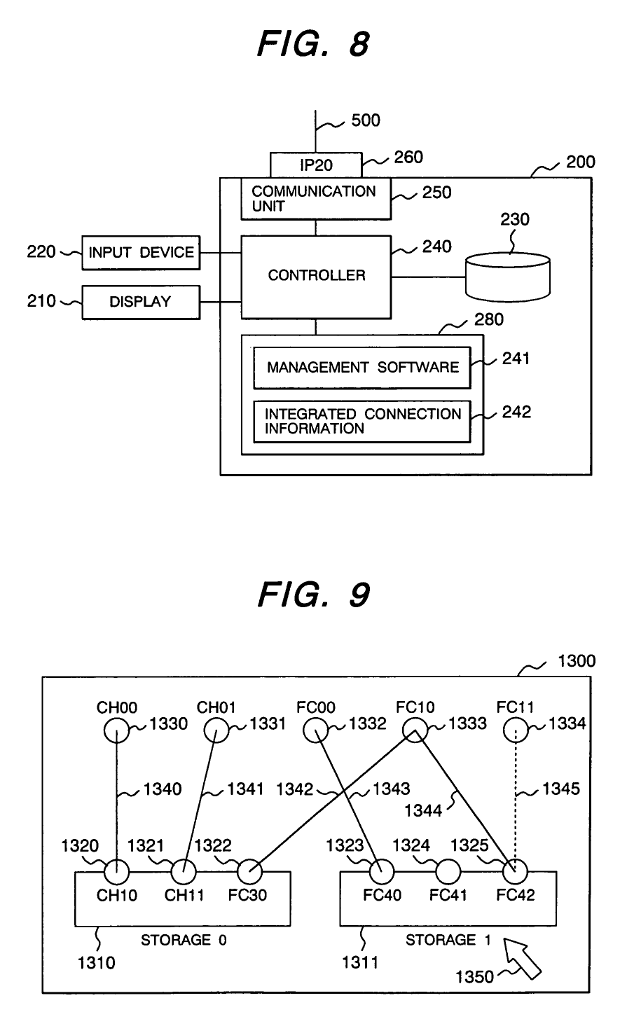

FIG. 8 shows the configuration of the management computer 200.

The management computer 200 comprises a main storage device 230, a controller 240, a storage unit 280, and a communication unit 250. The communication unit 250 has a communication port 260.

The display 210 is a monitor which a program running in the management computer 200 uses to present information to a user. According to the present embodiment, the display 210 is used to visualize the connection relationships within the computer system.

The input device 220 is a user interface which a user uses to give directions to a program running in the management computer 200, such as, a keyboard or a pointing device.

The main storage device 230 is a physical disk in which programs running in the management computer 200 and data to be dealt with by the programs are stored. However, the main storage device 230 is not an indispensable constituent feature of the present invention.

The programs (including management software 241) needed to validate the display 210, input device 220, and communication unit 250 are recorded in a recording medium such as a ROM, saved in the main storage device 230, and then loaded to the storage unit 280. Thereafter, the programs are run by the controller 240. The medium in which the programs are recorded may not be a CD-ROM but any other recording medium. The programs may be installed from the recording medium to the storage unit 280. Otherwise, the recording medium may be accessed over the network in order to use the programs. Moreover, the hardware configuration needed to validate the display 210, input device 220, communication unit 250, and management software 241 may be determined so that the hardware can operate independently of the controller 240 included in the management computer 200.

The management software 241 and integrated connection information 242 are stored in the storage unit 280. The management software 241 is a program for implementing a feature of visualizing the connection relationships among the components the computer system using the display 210. The integrated connection information 242 is information concerning the connection relationships between the computers and storage systems which the management software 241 visualizes using the display 210. A processing flow followed by the management software 241 and the data format of the integrated connection information 242 will be described later.

The management software 241 uses the communication unit 250 to acquire the pieces 1050 and 1150 of communication port information and the pieces 1051 and 1151 of connection information from the storage systems 1000 and 1100.

FIG. 9 shows a connection relationship diagram 1300 expressing the computer system shown in FIG. 1. The connection relationship diagram 1300 is displayed on the display 210 by the management software 241.

The connection relationship diagram 1300 contains a graphic 1310 expressing the storage system 1000, a graphic 1311 expressing the storage system 1100, graphics 1320 to 1322 expressing the communication ports 1010 to 1012 of the storage system 1000, graphics 1323 to 1325 expressing the communication ports 1110 to 1112 of the storage system 1100, graphics 1330 to 1334 expressing the communication ports 410 to 414 of the computers 400 to 402, and lines 1340 to 1345 expressing the connection relationships among the communication ports.

Moreover, a pointer 1350 is displayed on the display 210. A user handles the input device 220 connected to the management computer 200 so as to change the position at which the pointer 1350 is displayed. When the user changes the position of the pointer 1350 so that the pointer will point out a graphic contained in the connection relationship diagram 1300, the user can designate an object which the management software 241 should deal with.

Referring to the graphics 1310 and 1311, Storage 0 and Storage 1 are written below the graphics. These are identifiers assigned to the storage systems and used by the management software 241. The identifiers of the storage systems are designated by a user through a screen image displayed on the display 210 or properly produced by the management software 241.

Above or below the graphics 1320 to 1322 and the graphics 1330 to 1334 which express the communication ports, the communication port identifiers assigned to the communication ports are displayed.

Referring to the line 1340, the graphic 1320 expressing the communication port 1010 of the storage system 1000 is drawn at one end of the line, and the graphic 1330 expressing the communication port 410 of the computer 400 is drawn at the opposite end thereof. Each of the lines 1340 to 1345 is drawn to link the graphics expressing the communication ports. Thus, the connection relationships among the communication ports are expressed.

The line 1345 is a dashed line, thus specifying that the communications link between the communication port 414 and communication port 1112 has been lost. The lines 1340 to 1344 are solid lines, thus specifying that a communications link has been established between each pair of the communication ports expressed with the graphics linked by the lines.

In order to express connection relationships using such an expression form as the connection relationship diagram 1300, part of the display 210 connected to the management computer 200 or the whole thereof may be employed. All connection relationships may not be visualized at a time. A method of visualizing only a user-desired part of all connection relationships may be provided. Moreover, the present invention does not limit the form of expressing connection relationships to the form of the connection relationship diagram 1300.

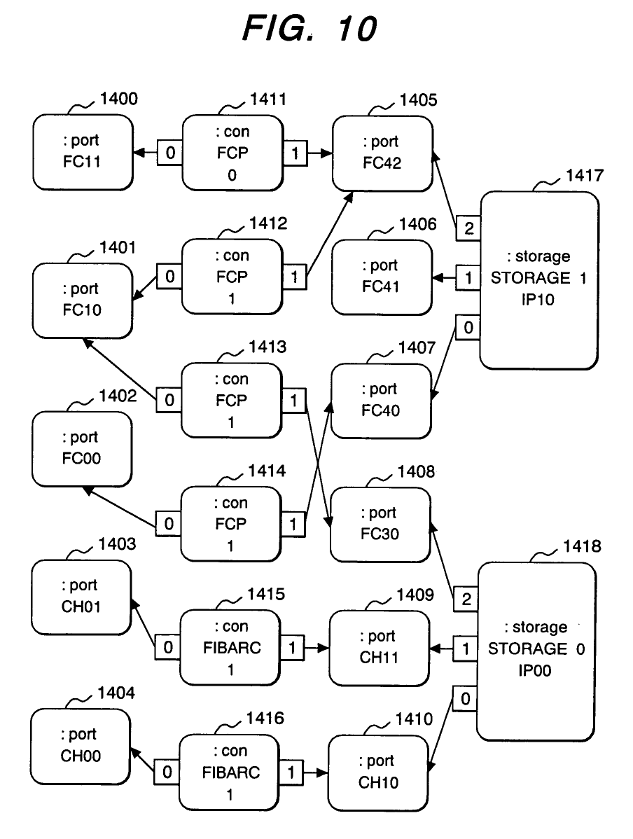

FIG. 10 shows information specified in the integrated connection information 242 preserved in the management computer 200.

Referring to FIG. 10, each of rectangles 1400 to 1418 having the corners thereof rounded expresses a block of a plurality of pieces of information specified in the integrated connection information 242. The blocks of information are equivalent to objects created using an object-oriented programming language. Thereinafter, the blocks of information shall be called objects.

The objects are classified by the property of information to be held. Categories into which the objects are classified are equivalent to classes whose concept is defined by a typical object-oriented programming language such as C++. Hereinafter, the categories of objects shall be called classes.

Referring to FIG. 10, a character string representing the class into which each object is classified is written in the uppermost line within each rectangle expressing an object.

The objects contained in the integrated connection information 242 are discriminated from one another with identifiers inherent to the objects. As the identifier of an object, an address in the storage unit 280 at which the object is stored may be adopted. Moreover, the management software 241 retrieves objects that belong to a specific class and obtains the list of identifiers assigned to the objects.

The objects 1400 to 1410 hold information concerning the communication ports 410 to 414, 1010 to 1012, and 1110 to 1112 respectively. Hereinafter, the class to which objects each holding information of a communication port shall be called a communication port class. In FIG. 10, “:port” is written in the uppermost line in a rectangle expressing each object that belongs to the communication port class. The object is associated with each communication port, and holds a communication port identifier assigned to the communication port. In FIG. 10, the lower one of two lines of character strings specified in an object represents a communication port identifier held in the object. For example, a communication port identifier of FC11 is held in the object 1400. The object 1400 is therefore associated with the communication port 414 of the computer 402.

Hereinafter, objects belonging to the communication port class shall be called communication port objects.

Objects 1411 to 1416 each represent the connection relationship between communication ports. The class to which objects each representing the connection relationship between communication ports shall be called a connection relationship class. The objects belonging to the connection relationship class shall be called connection relationship objects.

Referring to FIG. 10, “:con” is written in the upper line in each rectangle expressing a connection relationship object.

The identifiers held in two communication port objects are numbered. The same identifiers as the identifiers are held together with the numbers in the connection relationship object. The identifier held in a communication port object representing a communication port of a computer connected to a storage system is numbered 0. The identifier held in a communication port object representing a communication port of the storage system is numbered 1. The numbering is achieved by numbering a pair of elements corresponding to identifiers held in objects. Namely, the first one of the pair of elements is numbered 0, and the other one thereof is numbered 1.

In FIG. 10, an arrow indicates that a connection relationship object holds the same identifiers as communication port objects do. A numerical value written in a square located at the start point of an arrow represents a number assigned to an identifier that is held in a connection relationship object in contact with the square and that is the same as an identifier held in a communication port object. In FIG. 10, for example, the connection relationship object 1411 holds as number 0 the same identifier as the communication port object 1400 does, and holds as number 1 the same identifier as the communication port object 1405 does.

Each of the connection relationship object 1411 to 1416 holds the same identifiers as two communication port object do so as to express a connection relationship between communication ports represented by the communication port objects. In order to specify a connection relationship between two communication ports as information in the integrated connection information 242, the same identifiers as the identifiers held in the communication port objects holding the pieces of information concerning the communication ports are held in a connection relationship object.

Each of the connection relationship objects 1411 to 1416 also holds a character string representing a communications protocol adopted for a connection relationship represented by the object, and a value signifying whether a communications link has been established. Referring to FIG. 10, the character string representing a communications protocol and being held in each connection relationship object is written in the second line within a rectangle, and the value signifying whether a communications link has been established is written in the third line. The value signifying whether a communications link has been established is synonymous with the value that is contained in the connection information shown in FIG. 4 and that signifies whether a communications link has been established.

For example, the connection relationship object 1411 contains FCP as a character string representing a communications protocol, and contains 0 as a value signifying whether a communications link has been established.

Objects 1417 and 1418 contain information of the storage system 1100 and information of the storage system 1000 respectively. Hereinafter, the class to which objects holding information of a storage system shall be called a storage system class. An object belonging to the storage system class shall be called a storage system object. Referring to FIG. 10, “:storage” is written in the first line within a rectangle expressing a storage system object.

The storage system objects 1417 and 1418 each hold two pieces of information. One piece is an identifier of a storage system which is displayed on the screen 1300 below a graphic, which expresses a storage system. The other piece is a communication port identifier assigned to the management communication port of the storage system.

Referring to FIG. 10, an identifier of a storage system held in a storage system object is written in the second line within a rectangle expressing the storage system object. A communication port identifier assigned to the management communication port of the storage system connected on the network 500 is written in the third line.

Moreover, the storage system object holds the same identifiers as communication port objects do. This means that the storage system represented by the storage system object has communication ports. In other words, when a storage system object holds the same identifiers as communication port objects do, a storage system represented by the storage system object has communication ports represented by the communication port objects. Moreover, identifiers held in the communication port objects are numbered based on the internal communication port numbers assigned to the communication ports represented by the communication port objects, and held in the storage system object.

Referring to FIG. 10, an arrow is used to indicate that a storage system object holds, similarly to a connection relationship object, the same identifier as a communication port object does. A numerical value written within a square located at the start point of an arrow is a number assigned to an identifier that is held in the storage system object and that is the same as the identifier held in the communication port object, that is, an internal communication port number.

For example, in FIG. 10, the storage system object 1417 holds the same identifiers as the communication port objects 1405 to 1407 do. This reveals that the storage system 1100 has the communication ports 1113 to 1115. Moreover, the internal communication port numbers of the communication ports 1113 to 1115 range from 0 to 3.

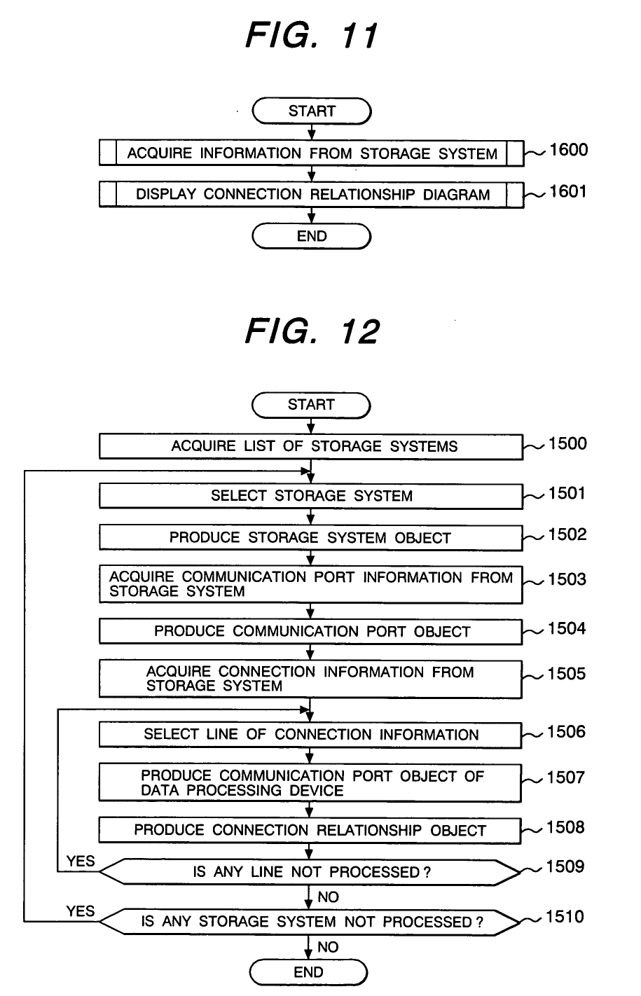

FIG. 11 describes an overall processing flow according to which management software 241 displays the connection relationship diagram 1300 on the display 210. As described in FIG. 11, the management software 241 acquires information of a connection relationship from the storage system (step 1600), and displays the connection relationship diagram 1300 (step 1601).

FIG. 12 describes a processing flow according to which the management software 241 acquires connection information from the storage system so as to construct integrated connection information 242 at step 1600 in FIG. 11.

At step 1500, the management software 241 acquires a list of communication port identifiers of the management communication ports of the respective storage systems included in the computer system. For the acquisition, a file which is saved in the main storage device 230 and in which the list of the communication port identifiers of the management communication ports of the respective storage systems is recorded, or the network 500 is searched. Otherwise, a user may use the input device 220 to give directions to the management software 241. As far as the computer system shown in FIG. 1 is concerned, the management software 241 acquires the identifiers IP00 and IP10 of the management communication ports 1080 and 1180 of the respective storage systems 1000 and 1100. The acquired identifiers of the management communication ports are used for data communication through which communication port information and connection information are acquired from the storage systems at steps 1503 and 1505.

At step 1501, the management software 241 selects one of the storage systems whose list is acquired at step 1500. Steps 1501 to 1509 constitute a loop to be repeated relative to each storage system. When step 1501 is performed for the second or successive time, a storage system other than the storage system selected previously is selected.

At step 1502, if a storage system object in which information of a selected storage system is held is not contained in the integrated connection information 242, the management software 241 produces a new object. At this time, the identifier of the storage system and the communication port identifier of the management communication port are held in the storage system object.

Whether a storage system object representing a selected storage system is contained in the integrated connection information 242 is verified by comparing the communication port identifier of the selected storage system, which is acquired at step 1500, with each of communication port identifiers held in all storage system objects contained in the integrated connection information 242.

At step 1503, the management software 241 acquires communication port information from the selected storage system. The management software 241 performs data communication over the network 500 so as to request the storage system to transmit communication port information. The storage system transmits the communication port information in response to the request. The management software 241 acquires the communication port information 1050 from the storage system 1000.

At step 1504, the management software 241 creates a communication port object, which represents the management communication port of the selected storage system, in the integrated connection information 242. However, if the communication port object is already contained in the integrated connection information 242, a new communication port object will not be created. Whether a new communication port object should be created is verified by comparing the communication port identifier of the management communication port of the storage system, which is contained in the communication port information acquired at step 1503, with communication port identifiers held in all communication port objects contained in the integrated connection information 242.

Moreover, the storage system object representing the selected storage system holds the same identifiers as the communication port objects, which represent the communication ports included in the storage system, do. At this time, the identifiers held in the communication port objects are numbered based on the internal communication port numbers of the communication ports represented by the communication port objects. If the identifiers held in the communication port objects are stored in the storage system, the identifiers will not be held in the storage system object.

At step 1505, the management software 241 acquires connection information from the selected storage system. Similarly to acquisition of the communication port information, the management software 241 requests the storage system to transmit connection information. The storage system transmits the connection information in response to the request. The management software 241 acquires the connection information 1051 from the storage system 1000.

At step 1506, the management software 241 selects the first row of items from the connection information acquired at step 1505. Steps 1506 to 1508 constitute a loop. When the step 1506 is performed for the first time, the leading row of items in the connection information is selected. At the second or subsequent time, the row next to the row selected previously at step 1506 is selected.

At step 1507, the management software 241 creates a communication port object representing a communication port of a computer identified with a communication port identifier that is specified as an item belonging to the row selected at step 1506. If the communication port object is already contained in the integrated connection information 242, a new communication port object will not be created. Whether a new communication port object should be created is verified by checking all the communication port objects contained in the integrated connection information 242 to see if any communication port object holds the communication port identifier specified as an item belonging to the selected row and assigned to the communication port of the computer. The communication port identifier specified as an item belonging to the selected row and assigned to the communication port of the computer is held in the created communication port object.

For example, the communication port identifier CH00 assigned to the communication port of the computer is specified as an item of the connection information 1052 belonging to both the first row and the second column. A communication port object 1410 holding the communication port identifier CH00 is created, and the same identifier is held as number 0 in the storage system object 1418.

At step 1508, the management software 241 creates a connection relationship object which represents a connection relationship between the communication port of the computer and the management communication port of the storage system that is specified as an item belonging to the row selected at step 1506. However, if the connection relationship object is already contained in the integrated connection information 242, a new connection relationship object will not be created. If the connection relationship object is already present, a value signifying whether a communications link is established may be different from the value specified in the row selected at step 1506. In this case, the value specified in the row is adopted.

Whether the connection relationship object is already present is verified by checking all the connection relationship objects contained in the integrated connection information 242 to see if any connection relationship object holds identifiers that are the same as the communication port identifier of the communication port of the computer held in a communication port object, and the communication port identifier of the management communication port of the storage system held in a storage system object. Moreover, it is verified whether any connection relationship object also holds a character string that is the same as the one which is specified as an item of a communications protocol belonging to the selected row in the connection information.

A connection relationship object 1410 is created from the first row of items in the connection information 1052. Namely, the connection relationship object 1410 holds the character string that is the same as the one specified in the third column 1212, and a value that is the same as the one specified in the fourth column 1213 and that indicates the state of a communications link. Thereafter, among the identifiers of the communication ports held in the storage system 1418 corresponding to the selected storage system 1000, a communication port object identified with the internal communication port number specified as an item of the connection information 1052 belonging to both the first row and the first column, that is, the communication port object 1410 is selected. The identifier that is the same as the one held in the communication port object 1410 is then held as number 1 in the created connection relationship object 1416. With respect to the communication port identifier stored in the first row second column 1211 of the connection information 1052, the identifier that is the same as the one held in the communication port object 1404 holding the communication port identifier is then held as number 0 in the created connection relationship object 1410.

At step 1509, the management software 241 verifies whether the processing from step 1506 to step 1508 has been completed for all the rows of items in the connection information acquired at step 1505. If any row of items has not been treated, the processing from step 1506 is performed again.

At step 1510, the management software 241 verifies whether the processing from step 1500 to step 1508 has been completed for all the storage systems included in the computer system. If any storage system has not been treated, the processing from step 1500 is performed again.

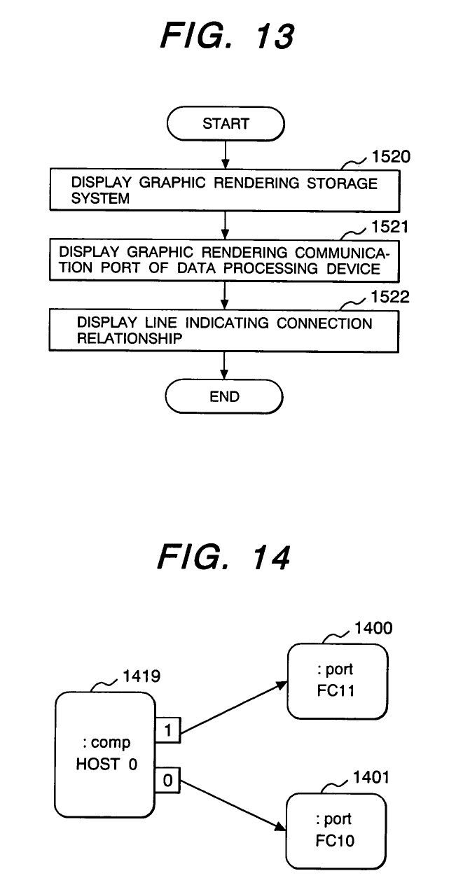

FIG. 13 describes a processing flow according to which the management software 241 displays the connection relationship diagram 1300 on the display 210 at step 1601 described in FIG. 11.

At step 1520, the management software 241 displays graphics expressing the storage systems.

At step 1520, one graphic is displayed relative to one storage system object contained in the integrated connection information 242. At this time, the identifier of the storage system held in the storage system object is also displayed. At the same time, graphics expressing the communication ports of the storage system are displayed based on the pieces of information, that is, the communication port objects holding the same identifiers as the storage system object does.

The integrated connection information 242 contains the storage system objects 1417 and 1418. According to the present embodiment, a graphic 1311 is displayed relative to the storage system object 1417, and a graphic 1310 is displayed relative to the storage system object 1418.

Moreover, the storage system object 1417 holds the same identifiers as the communication port objects 1405 to 1407 do. A graphic 1325 expressing the communication port object 1405, a graphic 1324 expressing the communication port object 1406, and a graphic 1323 expressing the communication port object 1407 are displayed above the graphic 1311 expressing the storage system object 1417. Moreover, when the graphics 1323 to 1325 expressing the communication port objects respectively are displayed, the communication port identifiers held in the respective communication port objects are displayed below the respective graphics.

Likewise, graphics 1320 to 1322 expressing the communication port objects 1408 to 1410 holding the same identifiers as the storage system object 1418 does are displayed relative to the graphic expressing the storage system object 1418. Moreover, when the graphics 1320 to 1322 expressing the communication port objects are displayed, the communication port identifiers held in the respective communication port objects are displayed below the respective graphics.

At step 1521, the management software 241 displays graphics expressing communication ports of computers according to the communication port objects contained in the integrated connection information 242.

The communication port objects contained in the integrated connection information 242 include the objects 1400 to 1410. Among them, the graphics expressing the communication port objects 1405 to 1410 have been displayed at step 1520 and will therefore not be dealt with below.

Graphics 1330 to 1334 expressing the other communication port objects 1400 to 1404 are displayed. The graphic 1330 expresses the communication port object 1404, the graphic 1331 expresses the communication port object 1403, the graphic 1332 expresses the communication port object 1402, the graphic 1333 expresses the communication port object 1401, and the graphic 1334 expresses the communication port object 1400.

The communication port identifiers of the communication ports held in the respective communication port objects are displayed above the respective graphics.

At step 1522, the management software 241 displays lines, each of which expresses a connection relationship between communication ports, according to the connection relationship objects contained in the integrated connection information 242.

Referring to FIG. 9, a line 1340 is represented by the connection relationship object 1416, a line 1341 is represented by the connection relationship object 1415, and a line 1342 is represented by the connection relationship object 1414. A line 1343 is represented by the connection relationship object 1413, a line 1344 is represented by the connection relationship object 1412, and a line 1345 is represented by the connection relationship object 1411. These lines are displayed so that each line will link the graphics expressing two communication objects which hold the same identifiers as the connection relationship object representing the line does.

Moreover, the kind of line to be displayed is varied depending on a value that is held in the connection relationship object representing each line and that signifies whether a communications link is established. Namely, if the value signifying whether a communications link is established is 1, a solid line is drawn. If the value is 0, a dashed line is drawn.

After the lines 1340 to 1345 are displayed, graphics 1390 to 1395 expressing communications protocols held in the connection relationship objects representing the lines are displayed.

A feature allowing a user to append information to the connection relationship diagram 1300 by operating the management computer 200 may be included in the management software 241. For example, the graphics 1333 and 1334 expressing communication port objects are actually associated with the communication ports 413 and 414 of the computer 402. When the relationship to the computer 402 is visualized, connection relationships will be more easily grasped. Now, a description will be made of a processing flow to be initiated by a user who directs the management software 241 to display a graphic expressing the computer 402 in the connection relationship diagram 1300.

A user handles the input device to select the graphics 1333 and 1334 pointed out by the pointer 1350, and directs the management software 241 to display a graphic, which expresses the computer 402, so that the graphic will overlap the two graphics. The management software 241 includes a feature that allows users to give directions by selecting items from general menus.

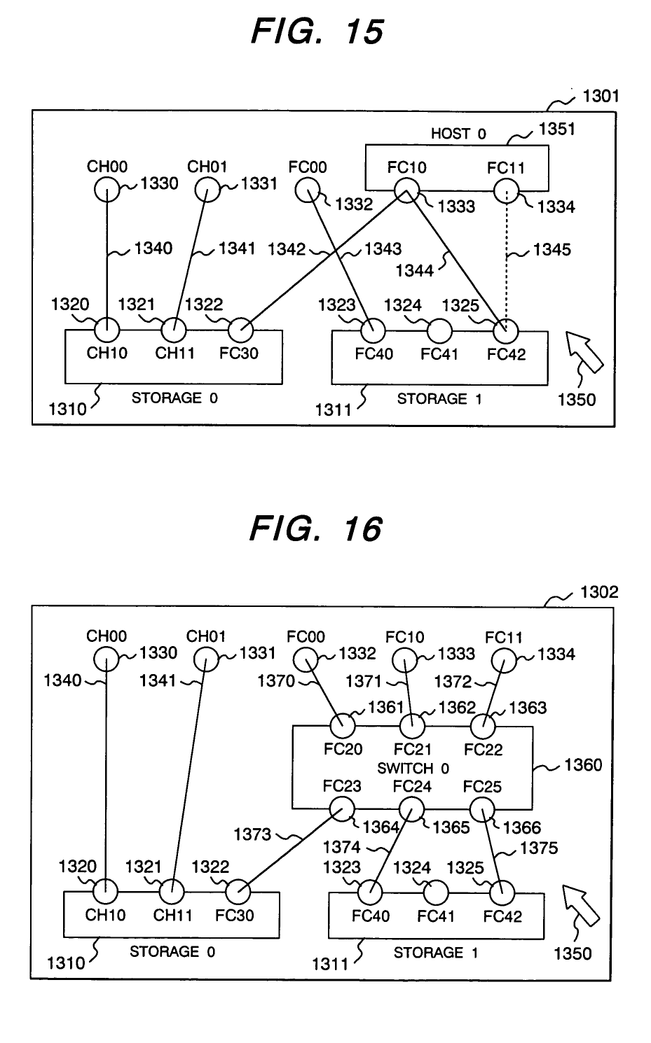

When the user performs the above action, the management software 241 creates an object 1419 shown in FIG. 14, and adds the object 1419 to the integrated connection information 242. The object 1419 holds the same identifiers as the communication port objects 1400 and 1401 expressed by the user-designated graphics do. The same identifier as the one held in the communication port object 1401 is held as number 0 in the object 1419, and the same identifier as the one held in the communication port object 1400 is held as number 1 in the object 1419. Moreover, an identifier Host0 of the computer that will be displayed on the display 210 is held in the object 1419. The identifier of the computer may be determined by a user or appropriately produced by the management software 241. The management software 241 displays a graphic 1351 as the one contained in a connection relation diagram 1301 shown in FIG. 15. The character string Host0 held in the object 1419 is displayed above the graphic 1351.

Moreover, assuming that the agent program runs in the computer 402 and a way of communicating with the agent program is known, the management software 241 may receive information from the agent program and create the object 1419 holding the information of the computer 402. Otherwise, a file containing the same information may be saved in the main storage device 230 included in the management computer 200, and the object 1419 may be created based on the information.

Now, a second embodiment of the present invention will be described below.

Management software included in the second embodiment visualizes the connection relationships among a storage system and computers on the basis of connection information received from an interconnection device. Moreover, the management software visualizes the connection relationships among the storage system and computers connected to the storage system on the basis of connection information received from the storage system.

According to the second embodiment, the connection relationships among the components of a computer system are visualized in the form of a connection relationship diagram 1302 shown in FIG. 16. When the connection relationship diagram 1302 is compared with the connection relationship diagram 1300 shown in FIG. 9, the connection relationship diagram 1302 includes a graphic 1360 having Switch0 written therein. The graphic 1360 expresses the interconnection device 300. Moreover, the connection relationship diagram 1302 does not, unlike the connection relationship diagram 1300, include the lines 1342 to 1345 each expressing a connection relationship between communication ports. Instead, lines 1370 to 1375 are displayed. Each of the lines 1370 to 1375 expresses a connection relationship between a communication port of the interconnection device 300 and a communication port of the computer or storage system. On the other hand, the other graphics bearing the same reference numerals as those in the connection relationship diagram 1302 have the same meanings as those in the connection relationship diagram 1300. The graphics are displayed in the same manner as those in the connection relationship diagram 1300.

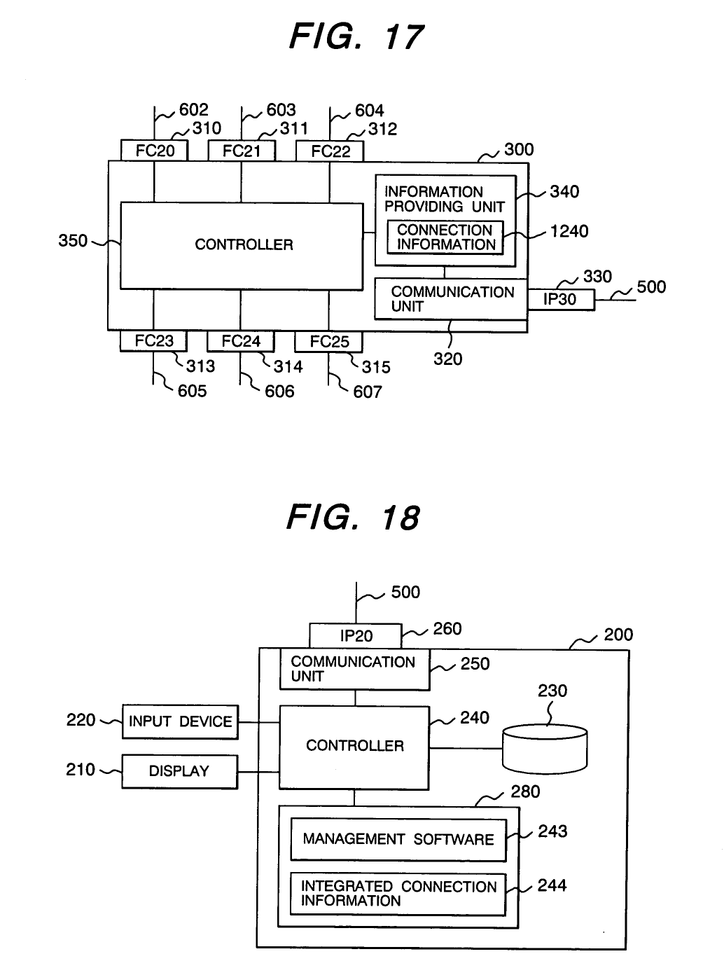

FIG. 17 shows the internal configuration of the interconnection device 300. The interconnection device 300 has a communication unit 320, an information providing unit 340, and a controller 350, in addition to the communication ports 310 to 315 and management communication port 330.

In the interconnection device 300, the communication ports 310 to 315 are numbered 0 to 5 and thus discriminated from one another. The numbers assigned to the communication ports 310 to 315 shall be called internal communication port numbers.

The communication unit 320 has the management communication port 330 and is responsible for data communication with the external computers over the network 500.

The information providing unit 340 serves as an acquisition unit for acquiring connection information 1240, which is concerned with each pair of a communication port of the interconnection device and a communication port of the data processing device connected to the interconnection device. The information providing unit 340 then transmits the acquired connection information 1240 to the management computer 200. The information providing unit 340 may transmit the connection information 1240 to the storage systems 1000 and 1100. The storage systems 1000 and 1100 may in turn transmit the connection information 1240 received from the information providing unit 340 to a management computer 200.

The controller 350 controls transmission of data through the communication port 310 to 315 so that the interconnection device can communicate data to external computers connected thereto through the communication ports 310 to 315.

FIG. 18 shows the internal configuration of the management computer 200 included in the second embodiment. According to the second embodiment, management software 243 and integrated connection information 244 are stored in a storage device 280 included in the management computer 200.

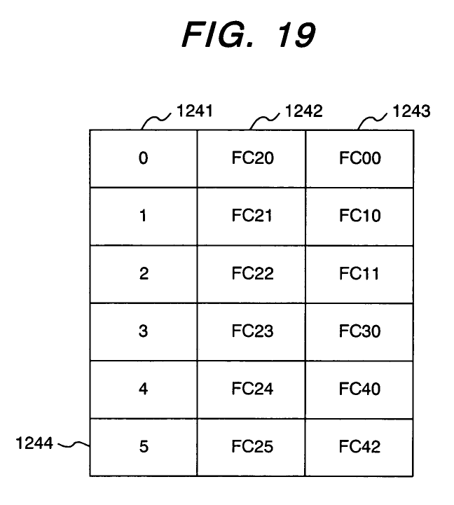

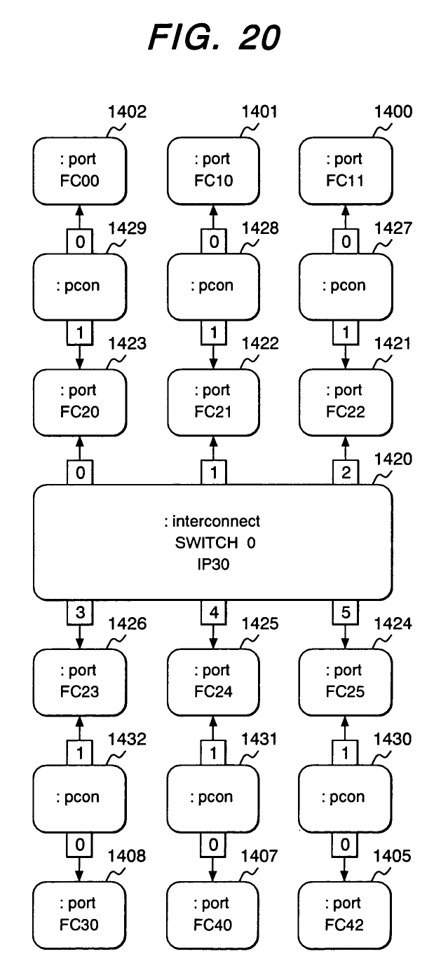

FIG. 19 shows the contents of the connection information 1240 preserved in the interconnection device 300.

The connection information 1240 is structured as a table having thee rows and six columns. The rows of items in the connection information 1240 specify connection relationships among the communication ports 310 to 315 of the interconnection device 300 and the communication ports of external computers connected to the communication ports 310 to 315.

The internal communication port numbers of the communication ports 310 to 315 of the interconnection device 300 are specified as the items belonging to both the respective rows and the first column 1241 in the connection information 1240. The communication port identifiers of the communication ports 310 to 315 discriminated from one another with the internal communication port numbers specified in the first column are specified in the second column 1242. The communication port identifiers assigned to the communication ports of the computer or storage system connected to the communication ports identified with the internal communication port numbers specified in the first column are specified in the third column 1243.

For example, the sixth row of items 1244 demonstrates that a communication port of the interconnection device 300 assigned an internal communication port number of 5 has a communication port identifier of FC25. A communication port having a communication port identifier of FC42 is connected to the communication port.

Now, the connection information 1240 is structured as a table having three rows and six columns. The present invention can be adapted to any interconnection device as long as the connection information concerning communication ports can be preserved in the interconnection device.

Now, the contents of information specified in the integrated connection information 244 and a processing flow for constructing the integrated connection information 244, which are employed in the second embodiment, will be described below.

FIG. 20 shows an object that holds information contained in the integrated connection information 244, or especially, information concerning the interconnection device 30, and relevant objects. In addition to the objects shown in FIG. 20, the objects contained in the integrated connection information 242 shown in FIG. 10 are contained in the integrated connection information 244. Objects bearing the same reference numerals as those shown in FIG. 20 are identical to those shown in FIG. 10. Incidentally, in FIG. 20, similarly to FIG. 10, an arrow signifies that an object holds the same identifier as other object does.

An object 1420 holds information concerning the interconnection device 300. The identifier Switch0 of the interconnection device 300 which is displayed in the graphic 1360 within the connection relationship diagram 1302, and the communication port identifier IP30 of the management communication port 330 are held in the object 1420. Hereinafter, the object holding the information concerning the interconnection device shall be called an interconnection device object, and the class to which the object belongs shall be called an interconnection device class.

Objects 1421 to 1426 are communication port objects holding information concerning the communication ports 310 to 315 of the interconnection device 300. The communication port object 1421 represents the communication port 312 and holds a communication port identifier FC22. The communication port object 1422 represents the communication port 311 and holds a communication port identifier FC21. The communication port object 1423 represents the communication port 310 and holds a communication port identifier FC20. The communication port object 1424 represents the communication port 315 and holds a communication port identifier FC25. The communication port object 1425 represents the communication port 314 and holds a communication port identifier FC24. The communication port object 1426 represents the communication port 313 and holds a communication port identifier FC23.

The interconnection device object 1420 holds the same identifiers as the communication port objects 1421 to 1426 do. This means that the interconnection device 300 represented by the interconnection device object 1420 has the communication ports 310 to 315 represented by the communication port objects 1421 to 1426. In the interconnection device object 1420, the identifiers are discriminated from one another with the internal communication port numbers assigned to the communication ports of the interconnection device 300 represented by the communication port objects.

Objects 1427 to 1432 express connection relationships among the communication ports 310 to 315 of the interconnection device 300 and the communication ports of a device or system connected to the interconnection device 300. The objects are discriminated from the connection relationship objects contained in the integrated connection information 242 shown in FIG. 10, and have “:pcon” specified in the uppermost line thereof. The objects shall be called interconnection device connection relationship objects.

Referring to FIG. 20, the object 1427 holds identifiers that are the same as those held in the communication port object 1400 representing the communication port 414 of the computer 402 and the communication port object 1421 representing the communication port 312 of the interconnection device 300. The object 1428 holds identifiers that are the same as those held in the communication port object 1401 representing the communication port 413 of the computer 402 and the communication port object 1422 representing the communication port 311 of the interconnection device 300. The object 1429 holds identifiers that are the same as those held in the communication port object 1402 representing the communication port 412 of the computer 401 and the communication port object 1423 representing the communication port 310 of the interconnection device 300. The object 1430 holds identifiers that are the same as those held in the communication port object 1405 representing the communication port 1112 of the storage system 1100 and the communication port object 1424 representing the communication port 315 of the interconnection device 300.

The object 1431 holds identifiers that are the same as those held in the communication port object 1407 representing the communication port 1110 of the storage system 1100 and the communication port object 1425 representing the communication port 314 of the interconnection device 300. The object 1432 holds identifiers that are the same as those held in the communication port object 1408 representing the communication port 1012 of the storage system 1000 and the communication port object 1426 representing the communication port 313 of the interconnection device 300.

As mentioned above, the interconnection device connection relationship object holds the same identifiers as the communication port objects representing two communication ports do, and thus expresses a connection relationship between the communication ports. Moreover, the identifiers held in the interconnection device connection relationship object are discriminated from each other with numbers 0 and 1. The identifier distinguished with number 0 is held in a communication port object representing a communication port of a system or device connected to the interconnection device 300, that is, a storage system or a computer. The identifier distinguished with number 1 is held in a communication port object representing a communication port of the interconnection device 300.

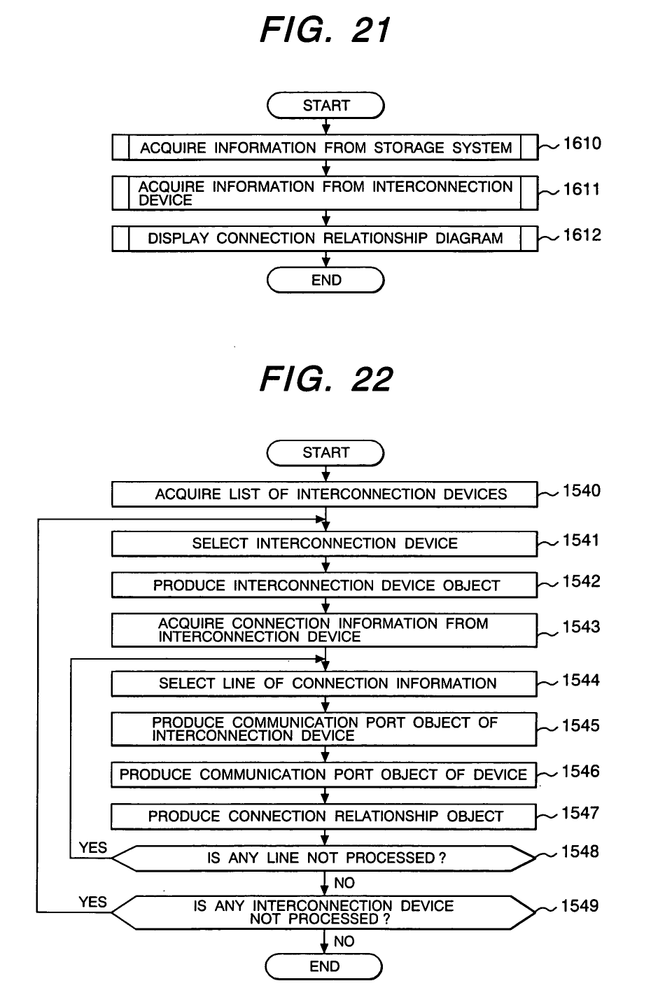

FIG. 21 describes a processing flow according to which management software 243 displays the connection relationship diagram 1302 on the display 210. As described in FIG. 21, the management software 243 acquires information of connection relationships from a storage system (step 1610), also acquires information of connection relationships from an interconnection system (step 1611), and displays the connection relationship diagram 1302. Incidentally, at step 1610, the same processing as that performed at step 1600 described in FIG. 11 is carried out. Steps 1610 and 1611 may be performed in that order or in reverse order.

FIG. 22 describes a processing flow according to which the management software 243 acquires information of connection relationships from an interconnection device and adds the information to integrated connection information 244 at step 1611.

According to the present embodiment, only the interconnection device 300 is included. The processing flow described in FIG. 22 is adaptable to a computer system including a plurality of interconnection devices.

At step 1540, the management software 243 acquires a list of communication port identifiers assigned to the management communication ports of interconnection devices included in a computer system. A file which is stored in the main storage device 230 and in which the list of communication port identifiers assigned to the management communication ports of interconnection devices is recorded, or the network 500 is searched for the list. In the computer system of the present embodiment, an identifier IP30 is retrieved. The retrieved identifier of the management communication port is used for data communication through which connection information is acquired from a communication unit.

At step 1541, the management software 243 selects one of the interconnection devices carried on the list acquired at step 1540. Steps 1541 to 1549 constitute a loop that is repeated for each interconnection device. When step 1541 is performed for the second or subsequent time, an interconnection device other than the previously selected one is selected. Hereinafter, a case where the interconnection device 300 is selected will be described for instance.

At step 1542, the management software 243 creates within the integrated connection information 244 an interconnection device object that holds information concerning the selected interconnection device. At this time, the created interconnection device object holds an identifier that will be displayed on the screen 1302. However, if the interconnection device object representing the selected interconnection device having a communication unit is already contained in the integrated connection information 244, a new object will not be created. Whether a new interconnection device object should be created is verified by checking if the integrated connection information 244 contains an interconnection device object that holds the communication port identifier assigned to the management communication port of the selected interconnection device.

At step 1543, the management software 243 communicates with the selected interconnection device over the network 500 and acquires connection information. Specifically, the connection information 1240 is acquired from the interconnection device 300.

Steps 1544 to 1548 constitute a loop within which the leading row of items in connection information to the last row thereof are treated one by one. Within the loop, communication port objects representing the communication ports of the interconnection device and an interconnection device connection relationship object are created. If necessary, communication port objects representing the communication ports of a system or device connected to the interconnection device are created.

At step 1544, the management software 243 selects one row of items in the acquired connection information. When the connection information is dealt with for the first time, the leading row of items is selected. At the second or subsequent time, the row next to the previously selected row is selected.

At step 1545, the management software 243 creates a communication port object representing a communication port of the interconnection device whose information is specified in the selected row. Herein, after the communication port object is created, a communication port identifier specified in the selected row is held in the created communication port object. Furthermore, the communication port identifier is numbered based on an internal communication port number specified in the selected row. The same identifier as the communication port identifier is then held in the interconnection device object created at step 1542.

However, if the communication port object is already held, a new communication port object will not be created. Whether a new communication port object should be created can be verified in the same manner as it is performed at step 1504 or 1507 in FIG. 12.

For example, a communication port object 1426 is created by referencing the row of items 1244 in the connection information 1240.

At step 1546, if necessary, the management software 243 creates objects representing the communication ports of an external computer connected to the interconnection device. Herein, all communication port objects contained in the integrated connection information 244 are checked to see if any communication port object holds a communication port identifier that is assigned to a communication port of the external computer and that is specified in the selected row. If no communication port object holds the communication port identifier, a communication port object is created. The communication port identifier is held in the created object.

At step 1547, if necessary, the management software 243 creates an interconnection device connection relationship object expressing a connection relationship between communication ports whose identifiers are specified in the selected row. Whether a new interconnection device connection relationship object should be created is verified by checking if communication port objects holding the two communication port identifiers specified in the row selected at step 1544 are contained in the integrated connection information 244. Moreover, it is checked if an interconnection device connection relationship object holding the same identifiers as the communication port objects do is contained in the integrated connection information 244. If a new interconnection device connection relationship object should be created, an interconnection device connection relationship object is created. Thereafter, the communication port identifier assigned to the communication port of the computer and held in the communication port object, which is specified in the row selected at step 1544, is numbered 1. An identifier that is the same as the communication port identifier is held in the created interconnection device connection relationship object. The communication port identifier assigned to the communication port of the interconnection device, which is specified in the row selected at step 1544, is numbered 0. An identifier that is the same as the communication port identifier is then held in the created interconnection device connection relationship object.

At step 1548, the communication software 243 verifies whether the processing from step 1544 to 1547 has been completed for all rows of items in the connection information acquired at step 1543. If any row has not been dealt with, the processing from step 1544 is performed again.

At step 1549, the communication software 243 determines whether the processing from step 1541 to 1549 has been completed for all interconnection devices included in the computer system. If any interconnection device has not been dealt with, the processing from step 1541 is performed again.

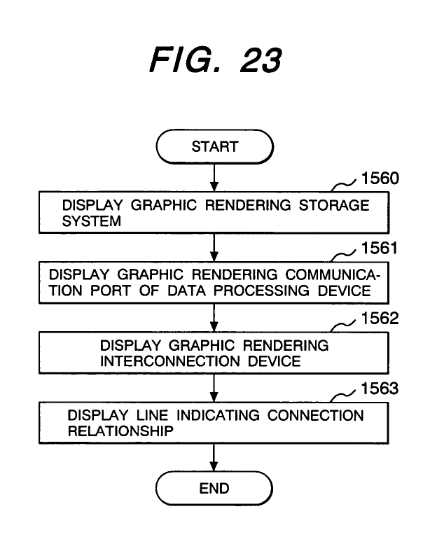

FIG. 23 describes a processing flow according to which the management software 243 displays the connection relationship diagram 1302 at step 1612.

At step 1560, the management software 243 displays a graphic expressing a storage system. At step 1561, the management software 243 displays graphics expressing the communication ports of a computer. The two steps are identical to steps 1520 and 1521 described in FIG. 13 but performed on the integrated connection information 244. At step 1562, the management software 243 displays a graphic expressing an interconnection device. At this step, one graphic is displayed relative to one interconnection device object contained in the integrated connection information 244. At this time, an identifier assigned to an interconnection device and held in the interconnection device object is also displayed.

At the same time, graphics expressing the communication ports of the interconnection device are displayed based on the information of the communication port objects holding identifiers that are the same as those held in the interconnection device object.

The integrated connection information 244 contains the interconnection device object 1420. According to the present embodiment, a graphic 1360 is displayed in order to express the interconnection device object 1420.

Moreover, the interconnection device object 1420 holds the same identifiers as the communication port objects 1421 to 1426 do. A graphic 1363 expressing the communication port object 1421, a graphic 1362 expressing the communication port object 1422, a graphic 1361 expressing the communication port object 1423, a graphic 1366 expressing the communication port object 1424, a graphic 1365 expressing the communication port object 1425, and a graphic 1364 expressing the communication port object 1426 are displayed so that the graphics will overlap the graphic 1311 expressing the interconnection device object 1420.

Moreover, when the graphics 1361 to 1366 expressing the communication port objects are displayed, the communication port identifiers held in the communication port objects are displayed inside the graphic 1360 expressing the interconnection device object that represents the interconnection device 300.

At step 1563, the management software 243 displays lines each expressing a connection relationship between the interconnection device and a system or device connected to the interconnection device.

At this step, lines 1370 to 1375 are displayed so that each of the lines will link the graphics expressing two communication port objects holding identifiers that are the same as those held in the interconnection device connection relationship objects 1421 to 1426 contained in the integrated connection information 244.

At step 1564, lines each expressing a connection relationship between a storage system and a computer are displayed. The processing of step 1564 is identical to that of step 1512 described in FIG. 13. However, when lines each expressing a connection relationship to the storage system are displayed, if lines each expressing a connection relationship of the communication port of the computer to the communication port of the interconnection device are already displayed, displaying the lines is omitted. This is intended to avoid making the connection relationship diagram 1302 complex, and is therefore not indispensable.

As a method for displaying all connection relationships among storage systems and computers without making a connection relationship diagram complex, a feature described below may be implemented in the management software 243. Namely, when a user handles the input device to move the pointer 1350 to a position at which the pointer overlaps a graphic expressing a communication port, a graphic expressing a communication port that represents a communication port having a connection relationship with the communication port represented by the communication port object is displayed while being highlighted. In this case, a connection relationship to the interconnection device and a connection relationship to a storage system can be displayed at the same time.

The methods for visualizing the connection relationships among the components of a computer system have been described according to the first and second embodiments.

In relation to the first and second embodiments, a change in any of the connection relationships among the components of the computer system has not been described at all. However, in the course of operating the computer system, a hardware or software failure may take place, a user may modify the configuration of the computer system, or a connection relationship between components may change. Consequently, the connection relationships in an actual computer system become different from a connection relationship diagram displayed by the management software. Therefore, the management software 241 or 243 regularly or irregularly acquires connection information from a storage system or an interconnection device so as to compare the connection information with information contained in the integrated connection information 242 or 244. When it is detected through the comparison that a connection relationship has changed, the integrated connection information 242 or 244 is reconstructed based on the information acquired from the storage system or interconnection device. A connection relationship diagram is redisplayed on the display 210.

As one way for allowing the management software 241 or 243 to detect a change in a connection relationship, a feature allowing a storage system or an interconnection device to notify the computers connected on the network 500 of a change in a connection relationship may be included. For example, the controller 1030 and information providing unit 1040 included in the storage system 1000 are designed to have the functions described below. Namely, when an event causing a connection relationship to change takes place, the controller 1030 included in the storage system 1000 updates the information contained in the connection information 1051, and notifies the information providing unit 1040 of the fact that the connection relationship has changed. In response to the notification, the information providing unit 1040 notifies the management computer 200 of the change in the connection relationship.

In response to the notification of the change in the connection relationship, the management computer 200 reacquires connection information from the storage system 1000, and redisplays a connection relationship diagram.

In the connection relationship diagrams 1300 to 1302, lines each linking graphics that express communication port objects are displayed in order to express the connection relationship between the communication ports represented by the communication port objects. Moreover, in the connection relationship diagram 1300, whether a communications link has been established is indicated by changing the kind of line. A communications protocol adopted for communication between communication ports, or a communication path between communication ports may be expressed by changing the kind of line. Moreover, the kind of line to be displayed may be the color or thickness of a line, whether a line displayed is flickered, or whether a line is composed of multiple lines.

This specification describes a way of visualizing connection relationships, especially, the connection relationships between a storage system and computers. The present invention can be applied to all computers that can be connected to the storage system.

According to the embodiments of the present invention, even when a computer in which an agent program cannot run is connected directly to a storage system, the connection relationships between the storage system and computer can be visualized.

Moreover, according to the embodiments of the present invention, an agent program is not indispensable. In such a situation that the influence of the agent program on the run of transaction software, which is a principal object of computers, has a significant meaning, or that the number of computers included in a computer system is large, a user can choose an option that the agent program is unused. For developers of management software, since development of an agent program is not a must, the cost of development can be minimized.

According to the present invention, there are provided management software, a management computer, and a management method capable of visualizing the connection relationships among a plurality of devices interconnected over a storage network without the necessity of implementing a connection information acquiring unit in an object computer.

What is claimed is:

1. A computer management system having an object computer, a storage system in which data to be communicated to the object computer is stored, and a management computer that manages the storage system and object computer, wherein:
said storage system comprises:
an acquisition unit for acquiring first connection information, which contains a communication port identifier of said object computer, and a communication port identifier assigned to the communication port of said storage system, from said object computer; and
a communication unit for transmitting said first connection information to said management computer; and
said management computer comprises:
a communication unit for receiving said first connection information from said storage system; and
a display that uses an output screen to visualize connection relationships between said storage system and computer on the basis of said first connection information.

2. A computer management system according to claim 1, wherein said first connection information further contains information representing a communications protocol adopted for data communication between connected communication ports or information representing a state of a communications link between communication ports.

3. A computer management system according to claim 1 or 2, wherein said acquisition unit included in said storage system acquires said first connection information when a data communications link is established between the communication ports of said computer and said storage system respectively.

4. A computer management system according to claim 1 or 2, further comprising an interconnection device connected to each of said object computer and said storage system, wherein:
said acquisition unit included in said storage system acquires said first connection information and said second connection information representing the connection relationships between said object computer and storage system from said interconnection device;
said communication unit included in said storage system transmits both said first connection information and said second connection information to said management computer;
said communication unit included in said management computer receives both said first connection information and said second connection information from said storage system; and
said display included in said management computer uses the output screen thereof to visualize the connection relationships among said storage system, said computer, and said interconnection device on the basis of said first connection information and said second connection information.

5. A computer management system according to claim 1 or 2, further comprising an interconnection device connected to each of said object computer and said storage system, wherein:
said management computer further comprises an acquisition unit that acquires second connection information, which represents the connection relationships between said object computer and said storage system, from said interconnection device; and
said display uses the output screen thereof to visualize the connection relationships among said storage system, said computer, and said interconnection device on the basis of said first connection information and said second connection information.

6. A computer management system according to claim 1, wherein when the connection relationships between said storage system and said computer have changed, said display included in said management computer uses the output screen thereof to visualize the connection relationships between said storage system and said computer on the basis of said first connection information that has been modified.

7. A computer management system according to claim 1, wherein:
said management computer includes a user interface via which a user-entered value is received; and
said display included in said management computer uses the output screen thereof to visualize the connection relationships between said storage system and said computer on the basis of said entered value and said first connection information.

8. A storage system which has a plurality of communication ports and in which data to be communicated to an object computer through one of the communication ports is stored, comprising:
an acquisition unit for acquiring first connection information, which contains a communication port identifier of said object computer, and a communication port identifier assigned to the communication port of said storage system, from said object computer; and
a communication unit for transmitting said first connection information to a management computer.

9. A management computer for managing an object computer and a storage system in which data to be communicated to the object computer is stored, comprising:
a communication unit for receiving first connection information, which contains a communication port identifier of said object computer, and a communication port identifier assigned to the communication port of said storage system, from said storage system; and
a display that uses an output screen thereof to visualize connection relationships between said storage system and said computer on the basis of said first connection information.

10. A management method for managing connection relationships between an object computer and a storage system in which data to be communicated to the object computer is stored, comprising the steps of:
acquiring first connection information, which contains a communication port identifier of said object computer, and a communication port identifier assigned to the communication port of said storage system, from said object computer; and
transmitting said first connection information to a management computer.

11. A management method for managing connection relationships between an object computer and a storage system in which data to be communicated to the object computer is stored, comprising the steps of:
receiving first connection information, which contains a communication port identifier of said object computer, and a communication port identifier assigned to the communication port of said storage system, from said storage system; and
using an output screen to visualize the connection relationships between said storage system and said object computer on the basis of said first connection information.

12. Management software for managing connection relationships between an object computer and a storage system in which data to be communicated to the object computer is stored, wherein:
said management software allows said storage system to act as:
means for acquiring first connection information, which contains a communication port identifier of said object computer, and a communication port identifier assigned to the communication port of said storage system, from said object computer; and
means for transmitting said first connection information to a management computer.

13. A management program for managing connection relationships between an object computer and a storage system in which data to be communicated to the object computer is stored, wherein:
said management program allows a management computer to act as:
means for receiving first connection information, which contains a communication port identifier of said object computer, and a communication port identifier assigned to the communication port of said storage system, from said storage system; and
means for using an output screen to visualize the connection relationships between said storage system and said object computer on the basis of said first connection information.
